(19) United States
(12) Patent Application Publication
(10) Pub. No.: US 2013/0302145 A1
(43) Pub. Date: Nov. 14, 2013

(54) WIND TURBINE

(71) Applicants: John Franz Hassenflu, Alpine, TX (US); Peter Michael Boedeker, San Antonio, TX (US)

(72) Inventors: John Franz Hassenflu, Alpine, TX (US); Peter Michael Boedeker, San Antonio, TX (US)

(73) Assignee: Far West Renewable Energy, Corp., Lakeway, TX (US)

(21) Appl. No.: 13/988,755

(22) PCT Filed: Nov. 22, 2011
(86) PCT No.: PCT/IB11/02761

§ 371 Date: Jul. 29, 2013

Related U.S. Application Data
(60) Provisional application No. 61/416,192, filed on Nov. 22, 2010.

(51) Int. Cl. F01D 5/14; F03D 11/00

(52) U.S. Cl. CPC F01D 5/141; F03D 11/00
USPC 415/125; 416/223 B; 416/174; 416/170 R

(57) ABSTRACT

A vertical axis wind turbine having multiple blades in which the root of each blade is oriented at an angle to a radial direction from a drive shaft and at least a portion each blade is swept back. The blades preferably have a symmetric partial aerofoil shape of generally V-shaped cross section of generally constant cross section.

### FIELD OF THE INVENTION

The present invention relates to wind turbine. In one aspect the wind turbine employs a swept blade design utilising lift and drag effects which enhances wind capture for down wind blades whilst shielding upwind blades. In another aspect an arrangement of magnets is utilised to mitigate frictional effects and facilitate starting of a wind turbine.

### BACKGROUND TO THE INVENTION

Wind turbines are generally categorised into drag machines, such as the Savonious turbine, lift machines, such as the Darrieus and common Horizontal axis turbines, and hybrid machines utilising both effects.

Drag machines are efficient at low wind speeds but are unable to fully utilise the available wind at higher wind speeds. Lift machines are efficient at high wind speeds but can be difficult to start and have poor wind utilisation at low wind speeds.

Hybrid turbines generally have a symmetric upwind and down wind blade profile (i.e. the effective area of the blade assembly exposed to the upwind side is similar to that of the down wind side). This, coupled with mechanical resistance to be overcome can make it difficult to start the turbine.

Further, most wind turbines are typically large structures with high visual impact that do not integrate well with buildings.

Spiral magnet arrangements have been proposed for use in motors where a magnet rotates about a central bearing within a spiral arrangement of magnets. Energy is injected once per cycle as the rotating magnet passes the transition between the ends of the spiral magnets to overcome the magnetic gradient step at this point. Such arrangements have to date only been employed in motor arrangements where an electromagnet is used to overcome the magnetic gradient step to continue rotation.

It is an object of the invention to provide a wind turbine having improved performance or to at least provide the public with a useful choice.

### SUMMARY OF THE INVENTION

According to a first aspect there is provided a vertical axis wind turbine including:
a. a shaft having a generally vertical axis of rotation; and
b. a rotor comprising a plurality of blades extending from the shaft, each blade having a top portion with a leading edge and trailing edge and a bottom portion with a leading edge and trailing edge wherein the top portion and bottom portion are connected along at least a portion of their respective leading edges to form a leading edge of the blade and the respective trailing edges of the top portion and bottom portion diverge, and wherein the root of each blade is oriented at an angle to a radial direction from the shaft and at least a portion each blade is swept back.

Preferably the ratio of the area of the upwind blades exposed to incident wind times the effective lever arm length is less than the area of the downwind blades exposed to the incident wind times the effective lever arm length. This is preferably less than 0.9, more preferably less than 0.8 and most preferably about 0.55. The blades preferably have a symmetric partial aerofoil shape of generally V-shaped cross section of generally constant cross section. The blades are preferably disposed at between 30 to 60 degrees, more preferably about 45 degrees, to the radial direction from the shaft. An axis along the root of each blade is preferably offset from the shaft by at least 5%, more preferably 10%, of the blade length of each blade. A continuously variable transmission may be employed to match power from the turbine to a generator.

According to another aspect there is provided a wind turbine including:
a. a drive shaft;
b. a rotor having one or more blades which rotate the drive shaft when driven by wind;
c. a plurality of rotating magnets attached to the drive shaft; and
d. a plurality of fixed magnets arranged about the drive shaft in the plane of the rotating magnets and spaced apart from the rotating magnets so as to produce a magnetic gradient that rotates the drive shaft in a desired direction of rotation for a majority of the angular orientations of the drive shaft.

The rotating magnets may be located a constant distance from the drive shaft and the fixed magnets arranged in a spiral about the drive shaft or the rotating magnets may be arranged in a spiral about the drive shaft and the fixed magnets arranged in a circle about the drive shaft.

The adjacent faces of the spirally arranged magnets and inner magnets may be of the same or of opposite polarity.

### BRIEF DESCRIPTION OF THE DRAWINGS

The invention will now be described by way of non-limiting example with reference to the accompanying drawings in which:

FIG. 1 shows a perspective view of a blade assembly for a wind turbine;

FIG. 2 shows a perspective view of the hub, drive shaft, transmission and generator for a wind turbine for use with the blade assembly shown in FIG. 1;

FIG. 3 shows a perspective view of the hub, magnetic bearing, and a magnet arrangement of FIG. 2 with the magnet arrangement exposed;

FIG. 4 shows a plan view of a blade of the blade assembly shown in FIG. 1;

FIG. 5 shows a cross-sectional view of the blade shown in FIG. 4 along line A-A;

FIG. 6 shows a plan view of the blade assembly shown in FIG. 1;

FIG. 7 shows a front view of the blade assembly shown in FIG. 6; and

FIG. 8 shows perspective view of a hub for mounting the blades to.

### DETAILED DESCRIPTION OF EMBODIMENTS OF THE INVENTION

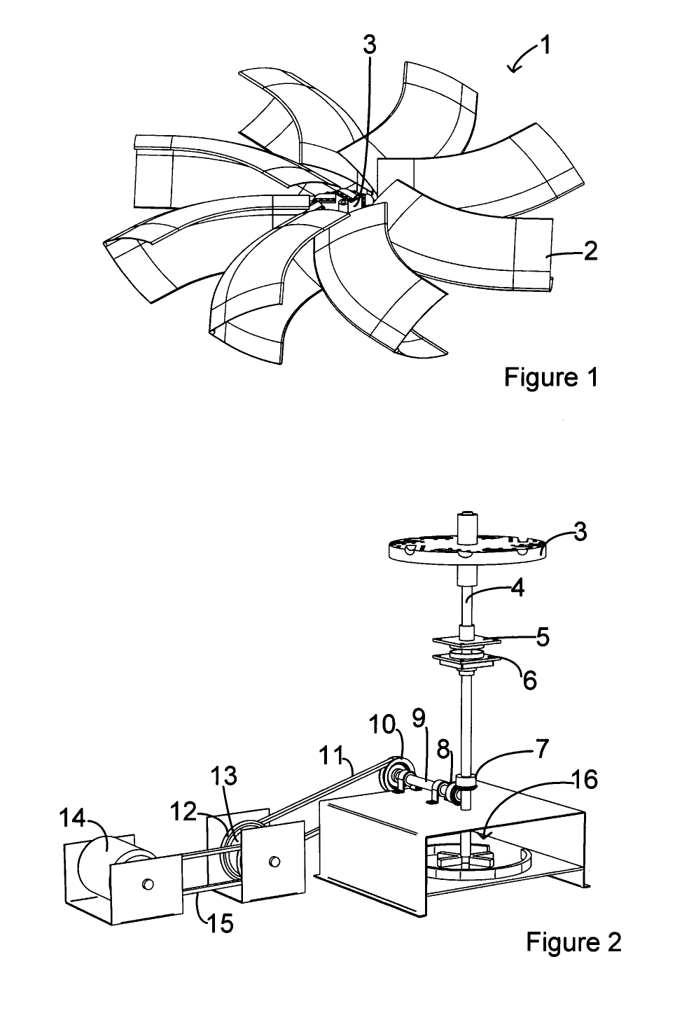

FIG. 1 shows a blade assembly 1 for the exemplary wind turbine shown in FIGS. 1 to 8. The blades of the assembly (one of which is indicated by numeral 2) are mounted to hub 3. Whilst in this embodiment 8 blades are shown any number from three or more blades could be employed depending upon the application. It will also be appreciated that the blade profiles may be adjusted within the teaching of this invention.

Referring to FIG. 2 the power conversion components of the turbine are shown. Hub 3 is secured to a vertical drive shaft 4 which is supported by magnets 5 and 6. Magnet 5 is a ring magnet secured to shaft 4. Magnet 6 is a ring magnet supported by a support structure. The opposing faces of magnets 5 and 6 are of opposite polarity so that the shaft is vertically supported due to the magnetic repulsion of the magnets, thus avoiding mechanical resistance from traditional bearings.

Bevel gears 7 and 8 are secured to shafts 4 and 9 so that drive shaft 9 drives pulley 10 with the force from drive shaft 4. It will be appreciated that the bevel gears may not be required where a different transmission system is employed. Pulley 10 drives transmission 13 via drive belt 11 and pulley 12. Drive belt 15 at the output of transmission 13 drives generator 14. Although in this embodiment an electrical generator is shown it will be appreciated that the wind turbine could alternately drive a pump or the like.

Transmission 13 may conveniently be a continuously variable transmission (CVT) which continuously adjusts the drive ratio from the drive shaft to generator. Not all applications will require a CVT transmission but where one is needed the CVT allows the gearing ratio to increase with the rotational speed of the drive shaft. P For example at start up the ratio may be one turn of the blade assembly 1 to two turns of the generator 14 and as the rotational speed of the blade assembly increases the transmission 13 may gear up to turn the generator 14 at a ratio of up to 8 times the turns of the blade assembly. The transmission 13 may also reduce the gearing ratio as the rotational speed of the blade assembly reduces to allow the generator 13 optimise power generation over a broad range of wind speeds. The transmission may also protect the wind turbine from over speed issues.

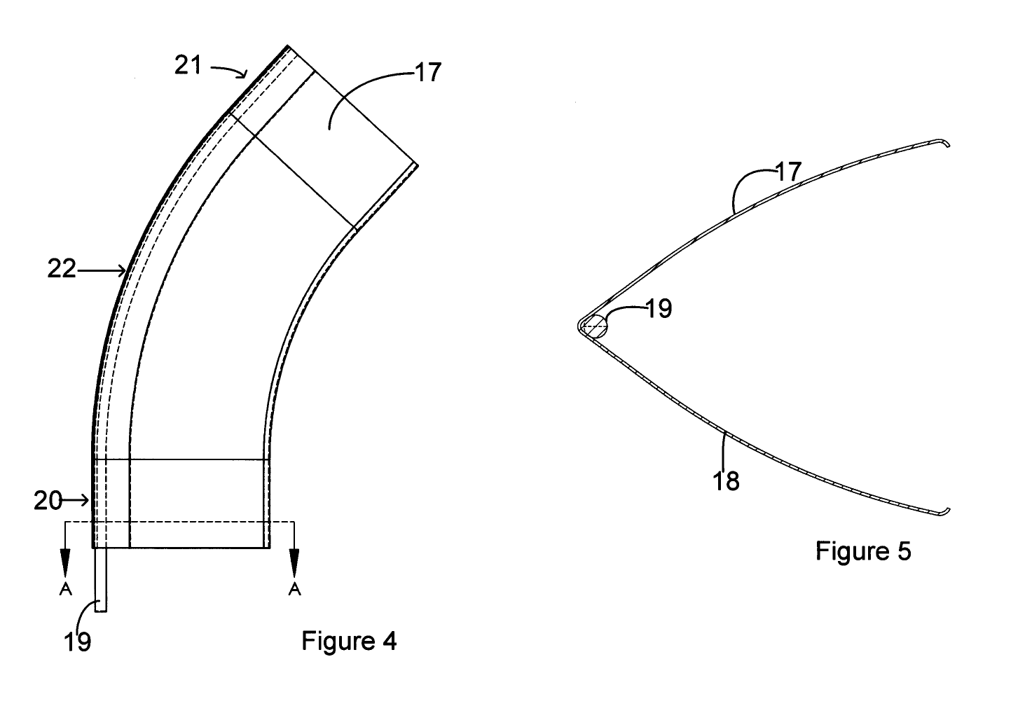

Referring now to FIGS. 4 and 5 the blade profile of each blade of the blade assembly 2 will be described. FIG. 5 shows the cross-section of blade 2 at the root of the blade as shown by the lines A-A in FIG. 4. In this example the blades have a constant cross-section but other cross-sections could be employed—such as reducing blade thickness towards the tips of the blades.

A support shaft 19 runs along the leading edge of the blade where top portion 17 and bottom portion 18 meet. The root end of shaft 19 of each blade is secured to hub 3. Each blade has a swept back leading edge as shown in FIG. 4 with straight sections 20 and 21 at each end and a middle section 22 of constant curvature. The cross-section of blade 2 is seen in FIG. 5 to be a partial aerofoil shape (i.e. just the leading portion of a symmetric aerofoil). The blade portions are of substantially equal cross sectional length and the respective trailing edges of the top portion 17 and bottom portion 18 diverge at about 45 degrees to form a generally V shaped cross-section. Each portion 17, 18 is convex with the centre of camber is located towards the front of the aerofoil.

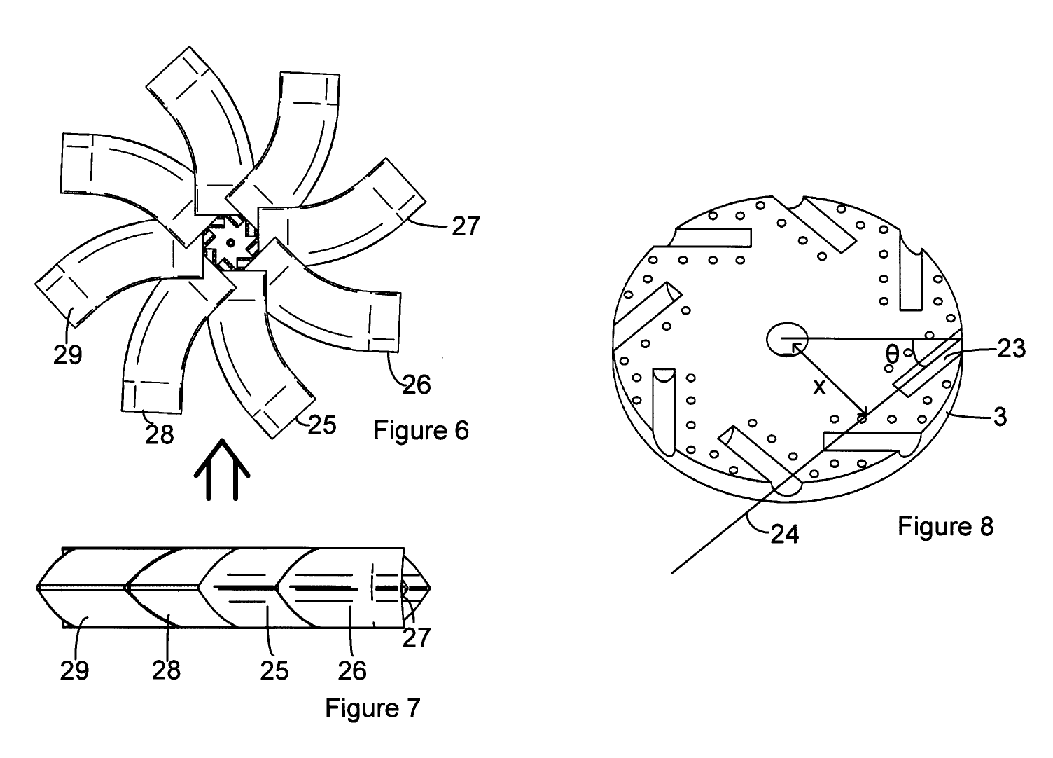

As shown in FIGS. 6 and 8 the root of each blade is oriented at an angle to a radial direction from the shaft and at least a portion each blade is swept back. As seen in FIG. 8 a cavity 23 for receiving the root portion of shaft 19 is disposed at an angle to the radial direction from shaft 4. The root portion of each shaft 19 is preferably disposed at an angle θ to the radial direction of between 30 to 60 degrees and preferably about 45 degrees. The axis 24 along the root of each blade is preferably offset from the shaft 4 by at least 5% of the blade length of each blade, more preferably at least 10%.

As can be seen when looking at FIGS. 6 and 7 the offset at the root and the swept blade design means that the upwind blades are partially shielded from the wind whilst some wind is directed towards the down wind blades. For example in the position shown in FIGS. 6 and 7 it will be seen that blade 25 partially shields upwind blades 26 and 27 from the incident wind whilst the leading edge of blade 25 directs wind into blade 28.

Due to the offset and swept blade design the force on blade 25 acts generally along the axis of shaft 4 whilst reducing force on the upwind blades and promoting rotation of the downwind blades. The ratio of the area of the upwind blades exposed to incident wind times the effective lever arm length is less than the area of the downwind blades exposed to the incident wind times the effective lever arm length. This ratio is preferably less than 0.9, more preferably less than 0.8 and most preferably is about 0.55.

Because of the offset of the Hub assembly there is a greater exposure of the downwind wind blades than with a standard hub with radially disposed blades. In this design there is up to an effective 2.25 down wind area blade exposure to an effective 1.25 upwind blade exposure. This assists slow speed start up and as the rotational speed increases the turbine increasing relies upon lift effects of the blade assembly to generate power.

The wind turbine described provides efficient utilisation of wind power over low and high wind speeds due to utilisation of lift and drag modes of operation. The offset swept blade configuration assists in starting and low wind operation by increasing the effective down wind capture compared to the upwind profile. The design also provides a low profile design generating low noise that is easily integrated with buildings and other structures.

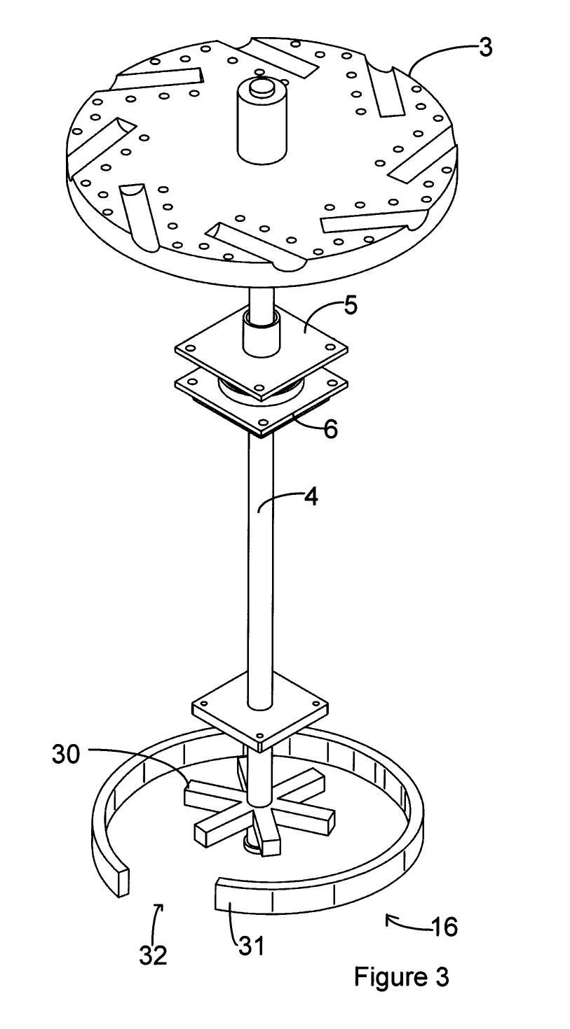

Referring again to FIG. 3 the spiral magnet arrangement will be described. A plurality of inner magnets 31 (six in this example) are secured at a constant distance from shaft 4 and a series of outer magnets 31 are arranged in a spiral arrangement with about shaft 4 and magnets 30. The drawing is illustrative only and the spacing between magnets 30 and 31 will generally be closer than shown.

Where all magnets are of the same polarity (i.e. the same magnetic pole facing the other magnet) the magnets 30 and 31 will repel. The spiral creates a magnetic gradient so that inner magnets 30 will be urged in a direction creating a greater separation between magnets 30 and 31. There will thus be a magnetic force urging rotation (in the direction of operation of the turbine) except at the transition of the spiral arrangement at 32. Here the magnetic gap closes and so a magnetic break force must be inserted to overcome the step in magnetic gradient.

Whilst the magnet arrangement described does not inject net energy into the system over an entire cycle it does serve to assist start up in counteracting some of the static frictional forces at start up. When the magnetic break force is overcome the rotor is accelerated and the static frictional forces are overcome to that force may be captured from the wind to provide inertia to the blade assembly to overcome the next magnetic break point.

Where magnets 30 are of opposite polarity to magnets 31 (i.e. an opposite magnetic pole facing the other magnet) the magnets 30 and 31 will attract. The spiral creates a magnetic gradient so that inner magnets 30 will be urged in a direction creating less separation between magnets 30 and 31. There will thus be a magnetic force urging rotation (in the direction of operation of the turbine) except at the transition of the spiral arrangement at 32. Here the magnetic gap opens and so a magnetic break force must be inserted to overcome the step in magnetic gradient.

It will be appreciated that the magnet arrangements could also be reversed so that a spiral magnet arrangement is attached to the drive shaft and the stationary magnets are all at a fixed distance from the drive shaft. It will be appreciated that what is required is a magnetic gradient that rotates the drive shaft in a desired direction of rotation for a majority of the angular orientations of the drive shaft to overcome frictional effects at start up and low speed operation. The spiral magnet arrangement 30 and 31 and the magnetic support bearings 5 and 6 thus reduce static resistance effects at start up and assist in low speed operation.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A vertical axis wind turbine including:
a. a shaft having a generally vertical axis of rotation; and
b. a rotor comprising a plurality of blades extending from the shaft, each blade having a top portion with a leading edge and trailing edge and a bottom portion with a leading edge and trailing edge wherein the top portion and bottom portion are connected along at least a portion of their respective leading edges to form a leading edge of the blade and the respective trailing edges of the top portion and bottom portion diverge, and wherein the root of each blade is oriented at an angle to a radial direction from the shaft and at least a portion each blade is swept back.

2. A vertical axis turbine as claimed in claim 1 in which the ratio of the area of the upwind blades exposed to incident wind times the effective lever arm length is less than the area of the downwind blades exposed to the incident wind times the effective lever arm length.

3. A vertical axis turbine as claimed in claim 2 wherein the ratio is less than 0.9.

4. A vertical axis turbine as claimed in claim 2 wherein the ratio is less than 0.8.

5. A vertical axis turbine as claimed in claim 2 wherein the ratio is about 0.55.

6. A vertical axis turbine as claimed in claim 1 wherein the blades have a convex partial aerofoil shape.

7. A vertical axis turbine as claimed in claim 6 wherein the centre of camber is located towards the front of the aerofoil.

8. A vertical axis turbine as claimed in claim 1 wherein the blades have a generally V-shaped cross section.

9. A vertical axis turbine as claimed in claim 8 wherein the blade portions arc of substantially equal cross sectional length.

10. A vertical axis turbine as claimed in claim 1 wherein the blade portions have symmetric profiles.

11. A vertical axis turbine as claimed in claim 1 wherein the blade portions are disposed at an angle of about 45 degrees to each other.

12. A vertical axis turbine as claimed in claim 1 wherein the blades are of generally constant cross section.

13. A vertical axis turbine as claimed in claim 1 wherein each blade has a swept leading edge.

14. A vertical axis turbine as claimed in claim 1 having three or more blades.

15. A vertical axis turbine as claimed in claim 1 having eight blades.

16. A vertical axis turbine as claimed in claim 1 wherein the blades are disposed at between 30 to 60 degrees to the radial direction from the shaft.

17. A vertical axis turbine as claimed in claim 16 wherein the blades are disposed at about 45 degrees to the radial direction from the shaft.

18. A vertical axis turbine as claimed in claim 1 wherein an axis along the root of each blade is offset from the shaft by at least 5% of the blade length of each blade.

19. A vertical axis turbine as claimed in claim 1 wherein an axis along the root of each blade is offset from the shaft by at least 10% of the blade length.

20. A vertical axis turbine as claimed in claim 1 wherein the turbine drives an electrical generator.

21. A vertical axis turbine as claimed in claim 20 wherein the output of the shaft is supplied to the electrical generator via a continuously variable transmission.

22. A vertical axis turbine as claimed in claim 1 wherein the turbine drives a pump.

23. A vertical axis turbine as claimed in claim 1 including a magnetic bearing vertically supporting the turbine.

24. A vertical axis turbine as claimed in claim 23 wherein the magnetic bearing includes a pair of opposed ring magnets about the shaft having opposed magnetic polarity on opposing faces.

25. A vertical axis turbine as claimed in claim 1 including a plurality of inner magnets at a constant distance from the shaft and a series of outer magnets arranged in a spiral arrangement with respect to the shaft and proximate the inner magnets.

26. A vertical axis turbine as claimed in claim 1 including a plurality of inner magnets arranged in a spiral about the shaft and a series of outer magnets arranged at a constant radius with respect to the shaft and proximate the inner magnets.

27. A vertical axis turbine as claimed in claim 25 wherein the adjacent faces of the spirally arranged magnets and inner magnets are of opposite polarity.

28. A vertical axis turbine as claimed in claim 25 wherein the adjacent faces of the spirally arranged magnets and inner magnets are of the same polarity.

29. A wind turbine including:
a. a drive shaft;
b. a rotor having one or more blades which rotate the drive shaft when driven by wind;
c. a plurality of rotating magnets attached to the drive shaft; and
d. a plurality of fixed magnets arranged about the drive shaft in the plane of the rotating magnets and spaced apart from the rotating magnets so as to produce a magnetic gradient that rotates the drive shaft in a desired direction of rotation for a majority of the angular orientations of the drive shaft.

30. A wind turbine as claimed in claim 29 wherein the rotating magnets are located a constant distance from the drive shaft and the fixed magnets are arranged in a spiral about the drive shaft.

31. A wind turbine as claimed in claim 29 wherein the rotating magnets are arranged in a spiral about the drive shaft and the fixed magnets are arranged in a circle about the drive shaft.

32. A wind turbine as claimed in claim 30 wherein the adjacent faces of the spirally arranged magnets and inner magnets are of opposite polarity.

33. A wind turbine as claimed in claim 30 wherein the adjacent faces of the spirally arranged magnets and inner magnets are of the same polarity.
